(19) United States
(12) Patent Application Publication
(10) Pub. No.: US 2026/0233709 A1
(43) Pub. Date: Aug. 13, 2026

(54) APPARATUS AND METHOD FOR CLEANING A VEHICLE WHEEL

(71) Applicant: WashTec Holding GmbH, Augsburg (DE)

(72) Inventors: Ulrich KÖLBL, Friedberg (DE); Fabian SANDER, Untermeitingen (DE)

(73) Assignee: WashTec Holding GmbH, Augsburg (DE)

(21) Appl. No.: 19/533,610

(22) Filed: Feb. 9, 2026

(30) Foreign Application Priority Data
Feb. 13, 2025 (EP) 25157809.2

(51) Int. Cl. B60S 3/04

(52) U.S. Cl. CPC B60S 3/042

(57) ABSTRACT

The disclosure relates to an apparatus for cleaning a vehicle wheel having a rotary table, which is rotatably mounted about a first rotational axis and which has a plurality of cleaning elements, and a first drive motor for creating a first rotary movement of the rotary table about the first rotational axis. The apparatus further includes a second drive motor for creating a second rotary movement and a transmission unit, which couples the second drive motor to the rotary table in such a way that the second rotary movement is transposed into a third movement of the rotary table, so that the first rotary movement and the third movement of the rotary table are superimposed. The disclosure further relates to a corresponding method for cleaning a vehicle wheel.

### FIELD OF THE INVENTION

The invention relates to an apparatus for cleaning a vehicle wheel, having a rotary table, which is rotatably mounted about a first rotational axis and which has a plurality of cleaning elements. The apparatus further comprises a first drive motor for creating a first rotary movement of the rotary table about the first rotational axis.

### BACKGROUND

For thorough cleaning of the often heavily polluted vehicle wheels, specially constructed wheel washers are used in washing systems. The construction of the wheel washers consists of several components, which interact to ensure efficient and thorough cleaning.

Rotating brushes are a central element of the wheel washer, which are positioned so that they are in direct contact with the wheels and/or wheel rims of the vehicle. The brushes consist of robust materials, which effectively remove the dirt without damaging the wheel rims. The brushes rotate with appropriate speed and exert sufficient pressure in order to even release stubborn soiling, such as brake dust, mud or road dirt.

An apparatus for cleaning vehicle wheels is known from EP 2 287 053 A2, which includes a rotational body, which can be rotated about a central axis and can be driven in rotation by a drive motor, with cleaning elements arranged on the end face. The rotational body in this apparatus includes at least one rotary table equipped with further cleaning elements, which is rotated by the rotation of the rotational body, not only about the central axis but also about its own longitudinal axis via a gearbox.

Additionally, the brushes can be mounted in a guide which is adapted to the wheel position. The brushes are driven mostly electrically or hydraulically, wherein the movements are precisely controlled, in order to avoid damaging the vehicle.

A further important component part of the wheel washer are nozzles, which targetedly spray water or cleaning solutions onto the wheels. These nozzles are often arranged so that they assist the brushes by soaking or rinsing off the dirt. High-pressure nozzles are also used in order to reach difficult-to-access points, such as the spoke intermediate spaces of the wheel rims, and to remove coarser soiling.

The disadvantage with the known solutions is that the brush hairs can be folded over by the rotation during the movement, due to the respective construction or the shape of the wheel to be cleaned, and thus penetration of the brush hairs into the intermediate spaces is prevented.

Therefore, there are points on the wheel rim which are not reached by the wheel washing brush purely rotating and on which the dirt remains, such as e.g. the spoke flanks, in the case of spoke rims on the outside of the rim flange and on the inside of the wheel hub.

### SUMMARY OF THE INVENTION

Therefore, an object of the invention is to specify an apparatus and a method for cleaning a vehicle wheel, which provides increased cleaning quality in a simple manner, so that improved cleaning of the vehicle wheel is enabled.

According to the invention, this object is solved by an apparatus having the features of claim 1 and by a method having the features of claim 11. Advantageous further developments result from the dependent claims.

A first aspect of the invention is an apparatus for cleaning a vehicle wheel. The apparatus comprises a rotary table, which is rotatably mounted about a first rotational axis and which has a plurality of cleaning elements, and a first drive motor for creating a first rotary movement of the rotary table about the first rotational axis. Additionally, the apparatus has a second drive motor for creating a second rotary movement and a transmission unit, which couples the second drive motor to the rotary table in such a way that the second rotary movement is transposed into a third movement of the rotary table, so that the first rotary movement and the third movement of the rotary table are superimposed.

The first rotational axis is an imaginary straight line about which the rotary table rotates. The rotary table thus performs autorotation, during which each point of the rotary table rotates about the first rotational axis. This first rotational axis runs in particular perpendicular to the plane of the rotary table and in particular goes through its geometric centre point.

The geometric centre point of the rotary table refers to the centroid of the area formed by the rotary table. It is located in the centre of the rotary table in relation to the symmetry or mass distribution. The geometric centre point can therefore be the centroid of the rotary table.

In particular, the rotary table is a circular disc shape. Therefore, the geometric centre point of the rotary table is the point from which all points on the circumference of the rotary table have the same distance, specifically the radius. It is located in the centre of the circle.

The second rotary movement is performed about a second rotational axis, which is an imaginary straight line about which the transmission unit is rotated. The second rotational axis runs in particular parallel to the first rotational axis.

The second rotary movement in particular causes the first rotational axis to rotate about a rotational axis offset from the first rotational axis, so that not only does the rotary table perform autorotation about the first rotational axis, but there also results a superimposed movement of the rotary table in the radial direction. Due to this superimposition of the first rotary movement with the third movement of the rotary table, the amplitude of the movement of the rotary table and thus also of the cleaning elements is increased in the radial direction. This means that it is advantageously possible to clean vehicle wheels or wheel rims which are larger than the maximum radial extension of the rotary table. Furthermore, the superimposition of the first rotary movement with the third movement of the rotary table advantageously means that folding-over of the cleaning elements, in particular at edges of openings of a wheel rim, is prevented as a far as possible, so that the cleaning elements reach difficult-to-access regions, such as for example gaps.

In addition to the rotary movement component about the first rotational axis, the movement of the rotary table or the cleaning elements receives a differently oriented movement component through the transmission of the second rotary movement. Due to this superimposition, the contact pressure force exerted by the cleaning elements and the pressing direction varies. Due to the variation in the contact pressure force, the friction between the cleaning elements and the vehicle wheel can also be increased. This movement superimposition furthermore leads to the cleaning elements being able to act in different force directions, and therefore gaps, such as intermediate spaces in the spokes, or difficult-to-access regions, such as rim flanks, of the vehicle wheel can be reached better. In particular, not only is a tangential friction force of the cleaning elements created by the first rotary movement, but friction forces also result which deviate from the tangential direction, and in particular forces are exerted in a direction parallel to a plane of the rotary table. In this case, the rotary table can define the reference pane. This superimposition with friction forces in different directions increases the washing quality and improves the cleaning of vehicle wheels.

With the apparatus for cleaning a vehicle wheel, it is advantageous if this apparatus has a control unit which is designed to control the first drive motor and the second drive motor independently from each other. The control unit can also comprise two separate partial units, which each control one of the drive motors.

Therefore, different washing programmes can be stored in the control unit which are selected and performed either manually by the operator or automatically based on sensor detection.

For example, this independent control enables the frequency or the superimposition of the first rotary movement and of the third rotary movement to be adapted to the degree of soiling or the size of the respective vehicle wheel, in order to obtain optimised cleaning results.

Furthermore, it is advantageously possible to achieve optimum superimposition of the first rotary movement with the third movement due to the independent control of the drive motors.

It is particularly advantageous with the apparatus for cleaning a vehicle wheel if the control unit controls the first drive motor and the second drive motor such that the angular velocity of the first rotary movement and the angular velocity of the second rotary movement do not have a common multiple.

This creates superimposition of vibrations of different frequencies. Therefore, irregular, aperiodic or complex movement is created, which causes the cleaning elements to act on the regions of the vehicle wheel from different directions. This type of movement guarantees that the individual cleaning elements of the rotary table always clean different regions of the vehicle wheel per cycle and therefore reach as many of the difficult-to-reach or -access regions of the vehicle wheel as possible.

With the apparatus for cleaning, it can be advantageous that the transmission unit has a transmission element, which is designed to transmit the second rotary movement of the second drive motor as a third movement to the first rotational axis of the rotary table.

The transmission unit advantageously enables a simple connection to the second drive motor and thus makes it easier to intercept the second rotary movement in order to transpose this into the third movement, in particular a rotational movement, which differs from the first rotary movement.

In a further embodiment, the transmission unit of the apparatus for cleaning a vehicle wheel has a first crankshaft connecting rod and a second crankshaft connecting rod. In this case, the first crankshaft connecting rod and the second crankshaft connecting rod are each coupled to the rotary table, wherein the first crankshaft connecting rod is coupled to the second drive motor and wherein the first and the second crankshaft connecting rods are coupled to each other via a web, in particular a fastening web. Accordingly, the crankshaft connecting rods can be fastened into the bearings of the web. The web or the fastening web can therefore be fixed in position and serve as a fixed point.

In a further exemplary embodiment, a third crankshaft connecting rod is used. In this case, a plane can be defined advantageously.

In the present case, a crankshaft connecting rod is understood as a mechanical arrangement which consists of a crankshaft and a connecting rod. In this case, the connecting rod of the respective crankshaft connecting rod is connected to the crankshaft in a parallel and offset manner.

In one exemplary embodiment, the crankshaft of the first crankshaft connecting rod is rotationally driven with the second drive motor. The crankshaft of the second crankshaft connecting rod is again coupled to the first crankshaft connecting rod via the web so that the rotation is transmitted.

Therefore, the first crankshaft connecting rod performs the second rotary movement so the second rotary movement is transmitted to the second crankshaft connecting rod via the web, in particular the fastening web. The respective connecting rod of the crankshaft connecting rods can be connected to the transmission element. When the crankshaft of the respective crankshaft connecting rod rotates, the connecting rod performs a circular movement, the third movement, about a third rotational axis. Due to the superimposition of the first rotary movement of the rotary table with the third movement, the cleaning of the vehicle wheel is optimised.

The third movement leads to the rotary table or the cleaning elements performing a rotary movement, in particular a circular movement, the respective rotational axes of which are substantially different from the first rotational axis of the rotary table and is spaced apart from this.

The first rotary movement is an autorotation of the rotary table about the first rotational axis. The third movement is in particular a circular movement of the rotary table, during which the orientation of the rotary table does not change in its plane, i.e. the rotary table does not perform autorotation. Considering only the third movement, each point on the rotary table rotates about a different axis.

Furthermore, with the apparatus it can be advantageous if the first crankshaft connecting rod and the second crankshaft connecting rod are mounted in a respective rotary bearing, wherein the rotary bearing stabilises the respective crankshaft of the first and second crankshaft connecting rods in a plane perpendicular to the crankshafts. In particular, the crankshaft connecting rods are stabilised in a direction which runs perpendicular to the crankshaft through the bearing point of the crankshaft of the crankshaft connecting rod.

In this design, it can further be an advantage if the first crankshaft connecting rod and the second crankshaft connecting rod are each mounted in a rotary bearing such that they can rotate freely. This enables optimum transmission of the second rotary movement.

With the apparatus for cleaning, it is advantageous if the third movement is a periodic rotational movement, in particular a periodic circular movement. In this case, the radius of the third movement is in particular smaller than the radius of the rotary table, e.g. less than 50%, preferably less than 30%, more preferably less than 20% of the radius of the rotary table.

The radius of the third movement is determined by the crank arm length and corresponds to the distance between the crankshaft and the connecting rod of the two crankshaft connecting rods. Based on the crank arm length of the respective crankshaft connecting rod, the cleaning can be performed with a comparatively small installation space of the apparatus. In this case, the distance between the two crankshaft connecting rods is chosen so that these do not touch.

Due to this movement with a smaller radius and the offset rotational axes, the intermediate spaces of the wheel rims of a vehicle wheel can be better reached and cleaned.

This type of movement can be transposed particularly simply, as then the second rotary movement can also be uniform.

To increase the amplitude and thus the possibility of cleaning larger vehicle wheels by means of the apparatus, it can be advantageous if the maximum radial deflection of the rotary table created by the third movement increases the maximum radial extension of the rotary table by at least 3%, preferably at least 5%, more preferably at least 10%.

In this case, the maximum radial extension of the rotary table corresponds to the radial distance of the first rotational axis from the radially outermost point of the rotary table, when the latter is not a circular-disc-shaped, for example. In the preferred case that the rotary table is a circular-disc-shaped, the maximum radial extension corresponds to the maximum radius of the rotary table.

For efficient superimposition of the second rotary movement, on the one hand, and of the first rotary movement, on the other hand, in order to further improve cleaning, it is advantageous if the first rotary movement of the rotary table and the third movement of the rotary table are performed in the same movement plane, wherein the movement plane is perpendicular to the first rotational axis of the rotary table.

In order to further improve the efficiency and the result of the cleaning by means of the apparatus for cleaning, the first drive motor can be designed to be operated in pendulum operation. In this case, the pendulum movement can be performed in an angle range from +/−5° to +/−50°, preferably +/−5° to +/−35°, more preferably +/−5° to +/−20°. Additionally or alternatively, it can be an advantage if the second drive motor is also operated in pendulum operation.

Pendulum operation is understood to be an operating mode in which the respective drive motor is operated alternately in an opposing rotational direction. Therefore, instead of a continuous rotational movement, the drive motor performs a back and forth oscillating rotational movement. The pendulum cycles and the speed of the rotary table are dependent on the size of the vehicle wheel and the number of spokes. In this case, it is conceivable that the speed during pendulum operation corresponds to at most 50%, preferably at most 30%, more preferably at most 20%, of the speed during rotating operation.

In one exemplary embodiment, the apparatus is designed so that the first drive motor performs a pendulum movement in a first cleaning phase, and rotates at least one full revolution in a second cleaning phase. In the second cleaning phase, the first drive motor can perform a further pendulum movement, for example, which comprises a rotation, however, which is greater than 360°, or the first drive motor is operated so that it rotates with a defined angular velocity at least in at a specified time interval.

Furthermore, with the apparatus for cleaning, it is advantageous if a feed unit is provided. This enables at least one of the drive motors, in particular the second drive motor, to feed the rotary table in the direction of the vehicle wheel, e.g. after starting-up, in order to exert a force, the so-called feed force, between the cleaning elements and the vehicle wheel in the axial direction. This feed force enables the immersion of the cleaning elements into the openings of the vehicle wheel, in particular into the openings of a wheel rim of the vehicle wheel.

A second aspect of the invention is a method for cleaning a vehicle wheel with an apparatus according to the first aspect of the invention. The method has the following steps:
creating the second rotary movement, in particular of the first crankshaft connecting rod, by means of the second drive motor, wherein the second drive motor and the rotary table are coupled by means of the transmission unit such that the second rotary movement is transposed into the third movement of the rotary table;
feeding the apparatus by means of a feed unit in the axial direction of a vehicle wheel to be cleaned, so that the cleaning elements exert a feed force on the vehicle wheel in the axial direction;
creating the first rotary movement of the rotary table about the first rotational axis by means of the first drive motor.

When the first and second rotary movement is performed, the first rotary movement and the third movement of the rotary table are superimposed, meaning that the amplitude of the movement of the rotary table or of the cleaning elements is increased. This leads to improved cleaning of the wheel rims, as the cleaning elements reach into the difficult-to-access regions of the wheel rim due to the in particular smaller radius of the third movement.

The method steps can be performed in different sequences.

Therefore, it can be advantageous for the method if the second rotary movement is created before the feeding of the apparatus and the first rotary movement is created after the feeding of the apparatus.

Therefore, in particular the third movement is performed during the feeding, so that the cleaning elements are moved into the difficult-to-access regions of the wheel rims, for example gaps or between the spokes.

If the first rotary movement is created preferably in addition to the second rotary movement, so that the third movement is superimposed with the first rotary movement, and the cleaning elements simultaneously exert a feed force on the vehicle wheel in the axial direction, the superimposed movement of the cleaning elements advantageously leads to the rotary table moving further in the direction of the vehicle wheel and the cleaning elements reaching yet further into difficult-to-access regions of the rims, for example gaps or between the spokes. This superimposition enables optimised cleaning of the vehicle wheel, as folding-over of the cleaning elements is prevented, meaning that the cleaning elements reach the intermediate spaces more easily.

It can furthermore be advantageous for the method if, in a first cleaning phase, the first drive motor is operated with a pendulum movement as a first rotary movement, wherein the pendulum movement has a maximum deflection between 5° and 20° in a rotational direction. In the first cleaning phase, in particular the first drive motor is operated with this pendulum movement as a first rotary movement and the second drive motor is simultaneously operated to create the third movement.

In this case, the maximum deflection describes the maximum magnitude of the angle by which the first drive motor deviates the rotary table from a rest position in a rotational direction while it is operated in pendulum operation.

If this pendulum movement is superimposed with the third movement, it is enabled that the cleaning elements are moved further or regularly into the difficult-to-access regions of the vehicle wheel. This improves the cleaning of the motor vehicle wheel.

In a further advantageous embodiment of the method, in a second cleaning phase, the first drive motor can be operated with a rotation about at least 360° as a first rotary movement. It is particularly advantageous if several complete revolutions are carried out. This rotation in combination with the third movement in turn enables the otherwise difficult-to-reach outer regions of the vehicle wheel to be reached.

With the method, it is possible that the first cleaning phase and the second cleaning phase alternate.

Furthermore, it can be advantageous for the method when the second drive motor creates a circular movement of the rotary table with 180 to 220 revolutions/min, preferably 190 to 220 revolutions/min, more preferably 200 to 210 revolutions/min, and the first drive motor creates a rotation or oscillation of the rotary table with 120 to 240 degrees/sec, preferably 150 to 210 degrees/sec, more preferably 170 to 180 degrees/sec.

Due to the high frequency of the second rotary movement, the cleaning elements perform small and fast circular movements, and therefore reach the intermediate spaces and gaps securely and quickly, and provide optimised cleaning of the motor vehicle wheels due to the smaller frequency of the first rotary movement.

### BRIEF DESCRIPTION OF THE DRAWINGS

The invention is explained in more detail using exemplary embodiments in connection with the schematic drawings having further characteristics.

These show:

FIG. 1 a schematic illustration of an exemplary embodiment of an apparatus for cleaning a vehicle wheel;

FIG. 2 a schematic illustration of the exemplary embodiment of the apparatus in an isometric view; and

FIG. 3 a schematic illustration of a method for cleaning a vehicle wheel with an apparatus according to FIG. 1 or 2.

### DETAILED DESCRIPTION

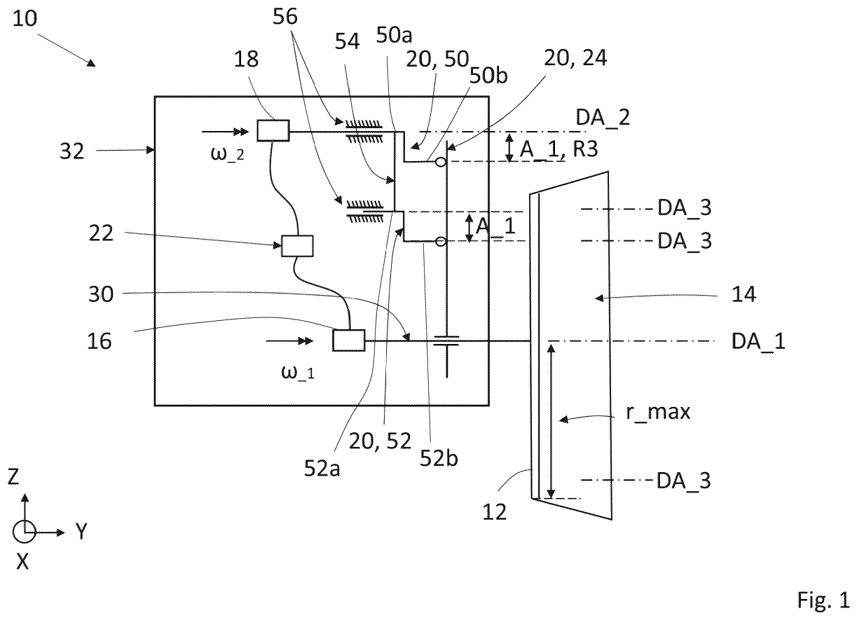

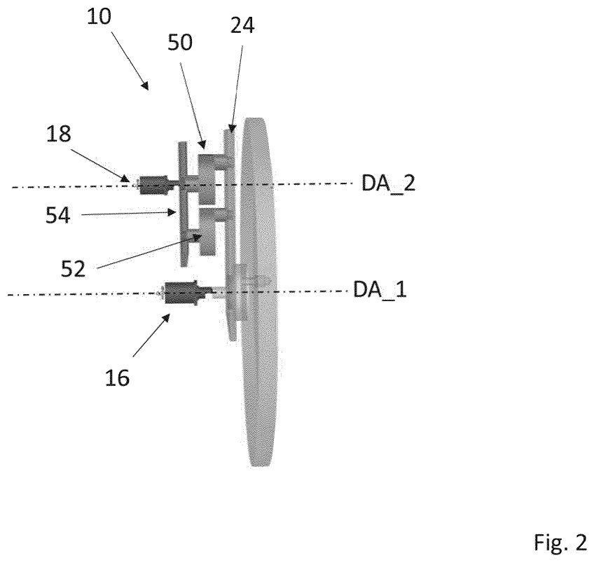

FIGS. 1 and 2 show an apparatus 10 for cleaning a vehicle wheel according to the exemplary embodiment in a different view in each case. The apparatus 10 has a first drive motor 16, a second drive motor 18, a rotary table 12 and a transmission unit 20. In this case, the rotary table 12 is rotatably mounted about a first rotational axis DA_1 and has a plurality of cleaning elements 14, as illustrated by way of example in FIG. 1.

Furthermore, the apparatus 10 has a feed unit 32, with which it can be fed in the direction of a vehicle wheel.

The rotational axes DA_1 and DA_2 of the two drive motors 16, 18 are arranged spaced apart from each other. The two drive motors 16, 18 each create a rotary movement about these rotational axes DA_1 and DA_2. The first drive motor 16 drives a shaft 30 and serves to create a first rotary movement ω_1 of the rotary table 12 about the first rotational axis DA_1 and the second drive motor 18 serves to create a second rotary movement ω_2 about the second rotational axis DA_2.

As shown in FIGS. 1 and 2, the transmission unit 20 comprises a transmission element 24 and a first crankshaft connecting rod 50 having a first crankshaft 50a and a first connecting rod 50b, a second crankshaft connecting rod 52 having a crankshaft 52a and a connecting rod 52b, and a fastening web 54. The first crankshaft connecting rod 50 and the second crankshaft connecting rod 52 are each coupled to the rotary table 12. For this, the first crankshaft 50a is coupled to the second drive motor 18 and the first and the second crankshafts 50a, 52a are coupled to each other via a fastening web 54. The crankshafts 50a and 52a are mounted in the fastening web 54 so as to freely rotate in a respective rotary bearing 56. This means that the crankshafts 50a and 52a are stabilised and fixed in a plane perpendicular to the crankshafts 50a, 52a. The second crankshaft connecting rod 52 is carried along by the driven first crankshaft connecting rod 50. This movement is transmitted to the rotary table 12 as a third movement via the end of the respective crankshaft connecting rod 50, 52 facing towards the rotary table 12.

In a further exemplary embodiment, yet a third crankshaft connecting rod can be used in order to define a plane.

The transmission unit 20 thus couples the second drive motor 18 to the rotary table 12 in such a way that the second rotary movement ω_2 is transposed into a third movement of the rotary table 12, so that the first rotary movement ω_1 and the third movement of the rotary table 12 are superimposed, so that the rotary table executes a complex superimposed movement.

During operation, the second drive motor 18 moves the first crankshaft 50a of the first crankshaft connecting rod 50 in rotation. This rotation is transposed into a rotation of the connecting rod 50b about the second rotational axis DA_2. The connecting rod 52b also performs a corresponding rotation by means of the transmission element 24 and because of the fixing of the crankshafts 50a, 52a, which rotation in turn is transmitted to the shaft 30 and the rotary table 12 as a third movement.

The third movement is a circular movement of the rotary table, during which the orientation of the rotary table does not change in its plane, i.e. the rotary table does not perform autorotation. Each point on the rotary table rotates about another axis, subsequently referred to as third axes DA_3.

If the first drive motor also moves the shaft 30 in a first rotary movement ω_1, i.e. autorotation of the rotary table 12 about the first rotational axis DA_1, this movement ω_1 is superimposed on the third movement, so that each point on the rotary table 12 and accordingly the cleaning elements 14 fastened thereto perform a complex movement.

In the exemplary embodiment of the apparatus 10, the third movement is thus a periodic rotational movement, in particular a periodic circular movement. The radius R3 of the third movement is in this case less than 50% of the radius R of the rotary table 12. The radius R3 of the third movement results from the distance A_1 between the crankshaft 50a, 52a and the connecting rod 50a, 50b of the respective crankshaft connecting rod 50, 52. The third movement leads to a radial amplitude of the movement of the rotary table 12, which increases the effective radius of the rotary table 12. This in turn furthermore leads to a cleaning element 14 fastened to the rotary table 12 performing a complex movement, so that the individual cleaning elements 14 of the rotary table 12 always clean different regions of the vehicle wheel, in particular also always from different directions, and reach as many of the difficult-to-reach or -access regions of the vehicle wheel as possible.

Due to the third movement, the effective radius of the rotary table about the radius R3 increases. Particularly good cleaning effects are initiated when the maximum radial deflection increases the maximum radial extension r_max of the rotary table 12 by at least 3%, preferably at least 5%, more preferably at least 10%.

The first rotary movement ω_1 of the rotary table 12 and the third movement of the rotary table 12 are performed in the same movement plane, wherein the movement plane is perpendicular to the first rotational axis DA_1 of the rotary table 12.

When the movement of the cleaning elements 14 is created by the drive motors 16, 18, these cleaning elements act in different force directions. This means that difficult-to-access regions, such as intermediate spaces of the spokes, of the vehicle wheels can be reached. Simultaneously, the influence on the friction between the cleaning elements 14 and the vehicle wheel changes frequently due to the superimposed movement. Both effects lead to improved cleaning of the vehicle wheel.

Furthermore, the cleaning elements 14 do not bend any more, as is the case with a merely rotating movement at the edges of openings of a wheel rim; instead they immerse into the openings so that they reach difficult-to-access regions, such as spoke flanks or spoke intermediate spaces, when they are fed in the axial direction of the vehicle wheel, i.e. an axial feed force acts on the cleaning elements 14.

The apparatus 10 further has a control unit 22 which is connected to the first drive motor 16 and the second drive motor 18 in a data-transmitting manner. Additionally, the control unit 22 is designed to control the first drive motor 16 and the second drive motor 18 independently of each other.

The control unit 22 controls the first drive motor 16 and the second drive motor 18 so that the angular velocity of the first rotary movement ω_1 and the angular velocity of the second rotary movement ω_2 do not have a common multiple.

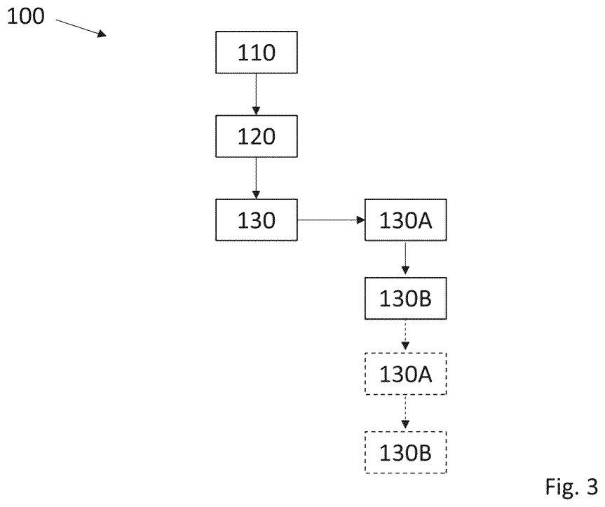

With reference to FIG. 3, an exemplary embodiment of the method 100 according to the invention for cleaning a vehicle wheel with an apparatus 10 according to FIG. 1 or 2 is described:

In step 110, the second rotary movement ω_2 is created by means of the second drive motor 18. As the second drive motor 18 and the rotary table 12 are coupled by means of the transmission unit 20, as described above, the second rotary movement ω_2 is transposed into the third movement. The rotary table 12 performs a rotational movement with the radius R3, without changing its orientation, however. For example, the uppermost point of the rotary table 12 remains the uppermost point even during the third movement of the rotary table 12 and a point on the right side of the rotary table 12 also remains on the right side even during the third movement of the rotary table 12.

In step 120, the apparatus 10 is moved by means of a feed unit 32 in the axial direction of a vehicle wheel to be cleaned until the cleaning elements 14 press against the vehicle wheel, i.e. exert a feed force on the vehicle wheel in the axial direction.

In step 130, the first rotary movement ω_1 of the rotary table 12 about the first rotational axis DA_1 is created by means of the first drive motor 16. In a first cleaning phase 130A, the first rotary movement ω_1 is a pendulum movement with a rotation angle of +/−10°. In this case, the second drive motor 18 is operated with a frequency of 15 to 30 Hz and the first drive motor 18 is operated with a frequency of 5 to 15 Hz.

Due to the pendulum movement about the first rotational axis DA_1, the superimposed third movement and the continued action of the feed force, the cleaning elements 14 infiltrate further into spoke flanges or spoke intermediate spaces. In particular, they do not break off before infiltration because of the relatively small pendulum angle. Simultaneously, the cleaning elements 14 perform a complex movement so that spoke flanges and spoke intermediate spaces are cleaned by forces acting from different directions.

After executing the first cleaning phase 130A, in a second cleaning phase 130B, the first drive motor 16 is operated with a rotation about at least 360° as a first rotary movement ω_1. For example, it can rotate with a constant angular velocity for a time period, in order to clean the radially outer regions of the wheel rim and the outer surface of the spokes.

Optionally, the cleaning phases 130A and 130B can be operated alternately multiple times.

Lastly, the apparatus 10 is moved away again from the vehicle wheel by the feed unit 32 and the drive by the drive motors 16, 18 is ended.

### LIST OF REFERENCE SIGNS

10 apparatus
12 rotary table
14 cleaning elements
16 first drive motor
18 second drive motor
20 transmission unit
22 control unit
24 transmission element
30 shaft
32 feed unit
50 first crankshaft connecting rod
50a first crankshaft
50b first connecting rod
52 second crankshaft connecting rod
52a second crankshaft
52b second connecting rod
54 fastening web
56 rotary bearing
100 method
110 creating the second rotary movement
120 feeding the apparatus
130 creating the first rotary movement
130A first cleaning phase
130B second cleaning phase
DA_1 first rotational axis
DA_2 second rotational axis
DA_3 third rotational axes
A_1 distance between the crankshaft and connecting rod
ω_1 first rotary movement
ω_2 second rotary movement
r_max maximum radial extension
x longitudinal direction
R3 radius of the third movement

1. An apparatus for cleaning a vehicle wheel, the apparatus comprising:
a rotary table, which is rotatably mounted about a first rotational axis and which has a plurality of cleaning elements,
a first drive motor for creating a first rotary movement of the rotary table about the first rotational axis
a second drive motor for creating a second rotary movement and
a transmission unit, which couples the second drive motor to the rotary table in such a way that the second rotary movement is transposed into a third movement of the rotary table, so that the first rotary movement and the third movement of the rotary table are superimposed.

2. The apparatus according to claim 1, wherein the apparatus has a control unit, which is designed to control the first drive motor and the second drive motor independently of each other.

3. The apparatus according to claim 2, wherein the control unit controls the first drive motor and the second drive motor such that the angular velocity of the first rotary movement and the angular velocity of the second rotary movement do not have a common multiple.

4. The apparatus according to claim 1, wherein the transmission unit has a transmission element, which is designed to transmit the second rotary movement of the second drive motor as a third movement to the first rotational axis of the rotary table.

5. The apparatus according to claim 1, wherein the transmission unit has a first crankshaft connecting rod and at least one second crankshaft connecting rod, which are each coupled to the rotary table, wherein the first crankshaft connecting rod is coupled to the second drive motor and wherein the first and the second crankshaft connecting rods are coupled to each other via a web.

6. The apparatus according to claim 5, wherein the first crankshaft connecting rod and the second crankshaft connecting rod are mounted in a respective rotary bearing, wherein the rotary bearing stabilizes the first and second crankshaft connecting rods.

7. The apparatus according to claim 1, wherein the third movement is a circular movement, wherein the radius of the third movement is less than 50% of the radius of the rotary table.

8. The apparatus according to claim 1, wherein the maximum radial deflection of the rotary table, created by the third movement, increases the maximum radial extension of the rotary table by at least 3%.

9. The apparatus according to claim 1, wherein the first rotational movement of the rotary table and the third movement of the rotary table are performed in the same movement plane, wherein the movement plane is perpendicular to the first rotational axis of the rotary table.

10. The apparatus according to claim 1, wherein the first drive motor is designed to be operated in pendulum operation.

11. A method for cleaning a vehicle wheel with the apparatus according to claim 1, the method comprising:
creating the second rotary movement by means of the second drive motor, wherein the second drive motor and the rotary table are coupled by means of the transmission unit such that the second rotary movement is transposed into the third movement of the rotary table;
feeding the apparatus by means of a feed unit in the axial direction of a vehicle wheel to be cleaned, so that the cleaning elements exert a feed force on the vehicle wheel in the axial direction;
creating the first rotary movement of the rotary table about the first rotational axis by means of the first drive motor.

12. The method according to claim 11, wherein the second rotary movement is created before the feeding of the apparatus and wherein the first rotary movement is created after the feeding of the apparatus.

13. The method according to claim 11, wherein in a first cleaning phase, the first drive motor is operated with a pendulum movement as a first rotary movement, wherein the pendulum movement has a maximum deflection between 5°and 20°.

14. The method according to claim 11, wherein in a second cleaning phase, the first drive motor is operated with a rotation about at least 360° as a first rotary movement.

15. The method according to claim 11, wherein the second drive motor creates a circular movement of the rotary table with 180 to 220 revolutions/min and wherein the first drive motor creates a rotation or oscillation of the rotary table with 120 to 240 degrees/sec.
